(19) United States
(12) Patent Application Publication
(10) Pub. No.: US 2009/0008898 A1
(43) Pub. Date: Jan. 8, 2009

(54) Scooter with pedals

(75) Inventor: Anthony Michael Walker, Goolmangar (AU)

Correspondence Address: HUDAK, SHUNK & FARINE, CO., L.P.A., 2020 FRONT STREET, SUITE 307, CUYAHOGA FALLS, OH, 44221, US

(73) Assignee: Misu Innovations Pty Ltd, Goolmangar (AU)

(21) Appl. No.: 11/795,110

(22) PCT Filed: Jan. 9, 2006
(86) PCT No.: PCT/AU06/00020

§ 371 Date: Mar. 24, 2008

(30) Foreign Application Priority Data
Jan. 11, 2005 (AU) 2005900089

(51) Int. Cl. B62M 1/02

(52) U.S. Cl. 280/256

(57) ABSTRACT

A vehicle (100) has a foot rest (111) on the frame (110), forwardly of the crankset (130) (with pedals (132)). The frame (110) and the arms (112) connecting the rear wheel (121) to the frame (110) have a height not greater than the height of the rear wheel (121) to enable the vehicle (100) to be operated as either a scooter or a bicycle.

### FIELD OF THE INVENTION

THIS INVENTION relates to a vehicle comprising features of a scooter and bicycle.

More particularly, the vehicle comprises a footrest located between a front wheel and rear wheel to allow use of the vehicle in a scooter-like manner; and a pair of pedals linked to the rear wheel to allow use of the vehicle in a bicycle-like manner.

### BACKGROUND OF THE INVENTION

To ride a standard bicycle, a pair of pedals is rotated, which is attached to a crankset having a chain ring, which is connected to a gear of a rear wheel via a chain. A larger diameter of the chain ring linked to a smaller diameter rear gear provides a mechanical advantage when pedalling the bicycle. A person sits on a seat attached to a frame of the bicycle, and their feet are placed on respective pedals located on either side of the frame. This arrangement is suitable for rotating the pedals; however, a central top bar of the frame restricts movement of the legs across the frame. This restricted movement prevents a user from easily swinging their legs across the frame, for example, when performing tricks or stunts. Also, a bicycle is bulky, which further limits an ability to perform tricks or stunts, for example those involving rotation of the bicycle about the rear wheel with a front wheel suspended from the ground. Further, a bicycle does not allow a person to easily push the bicycle in a scooter-like manner.

A scooter typically comprises a front and rear wheel attached by a frame having a footrest. A person places one foot on the footrest and rides the scooter by pushing off the ground with the other foot. However, a scooter may be difficult and tiring to ride as there is no mechanical advantage when pushing off the ground, as compared with a gear mechanism of a bicycle. Also, riding a typical scooter up hill is difficult and often a rider must dismount from the scooter and walk with the scooter up hill.

German patents 19542074 and 3936317 describe inventions modifying a bicycle by including a footrest of a scooter. These combined scooter/bicycles comprise a typical bicycle with a frame having a footrest and omit a top cross bar. Although these scooter/bicycles combine features of a bicycle and scooter, which allows a user to ride the scooter/bicycle by either peddling as a typical bicycle or pushing off the ground like a typical scooter, these scooter/bicycles are cumbersome and bulky. These scooter/bicycles, for example, are not suitable for a person who desires a light weight and less cumbersome scooter/bicycle.

### SUMMARY OF THE INVENTION

It is an object of the invention to provide an alternative or improvement to the abovementioned background art.

In a first aspect, the invention provides a vehicle comprising:

a frame;

a footrest attached to or formed integrally with the frame;

at least one arm attached to and extending from the frame;

a rear wheel attached to the arm(s);

a front wheel attached to a front part of the frame opposite the arm(s);

a crankset mounted to the frame between the front and rear wheels;

a drive mechanism operatively connecting the crankset to the rear wheel;

a pair of pedals attached to the crankset; and

a handle bar attached to a front part of the frame;

wherein:

the footrest is located between the front and rear wheels and the height of the frame and arm(s) between the footrest and rear wheel is substantially equal to, or less than, the height of the rear wheel when measured from a planar surface on which both the front and rear wheels are located thereon.

Preferably, the vehicle comprises a pair of arms.

In a second aspect, the invention provides a vehicle comprising:

a frame;

a footrest attached to or formed integral with the frame;

a single pair of arms attached to and extending from the frame;

a rear wheel attached to the pair of arms;

a front wheel attached to a front part of the frame opposite the arm;

a crankset mounted to the frame between the front and rear wheels;

a drive mechanism operatively connecting the crankset to the rear wheel;

a pair of pedals attached to the crankset; and

a handle bar attached to a front part of the frame;

wherein the footrest is located between the front and rear wheels.

Preferably, the footrest comprises a flat surface.

In one preferred form of the invention, the pair of arms extends from the frame below the crankset.

Preferably, the pair of arms extends from the footrest.

In another preferred form of the invention, the pair of arms extend from the frame above the crankset.

Preferably, the crankset comprises one or more chain rings.

Preferably, the rear wheel comprises one or more gears.

Preferably, the vehicle further comprises one or more braking devices.

Preferably, the braking device comprises one or more brake pads.

Preferably, the front wheel is attached to the frame via a fork.

Preferably, the fork comprises a suspension device.

Preferably, the arm comprises a suspension device.

Preferably, each suspension device comprises a spring or liquid filled cylinder.

More preferably, the liquid cylinder comprises a gas or oil filled cylinder.

Preferably, the drive mechanism connecting the crankset to the rear wheel comprises a chain.

Preferably, the vehicle further comprises a seat attachable to the frame.

It will be appreciated that a preferred form of the invention comprises a single pair of low set rear wheel support arms connecting the rear wheel to the frame; and the frame and pair of arms between the footrest and the rear wheel have a height equal to or less than a vertical height of the rear wheel when the vehicle is located with both the front and rear wheels in contact with a horizontal surface. This preferred form of the invention has the advantages of allowing a person to easily swing a leg over the rear wheel, for example, when performing tricks or stunts and renders the vehicle less cumbersome. As such the invention is also easily ridden off-road on a dirt surface as the invention is easy to manoeuvre. Also, the features of the preferred form of the invention reduces manufacturing costs. It will also be appreciated that a preferred form of the invention lacks a top cross bar characteristic of a typical bicycle and comprises a footrest, which allow the present invention to be easily used in a scooter-like manner.

Throughout this specification unless the context requires otherwise, the word “comprise”, and variations such as “comprises” or “comprising”, will be understood to imply the inclusion of the stated integers or group of integers or steps but not the exclusion of any other integer or group of integers.

### BRIEF DESCRIPTION OF THE DRAWINGS

In order that the invention may be readily understood and put into practical effect, preferred embodiments will now be described by way of example with reference to the accompanying drawings wherein like reference numerals refer to like parts and wherein:

FIG. 1 shows a side view of an embodiment of the invention comprising a low set rear wheel support arm extending from below a crankset without a suspension device (with an optional seat shown in dashed lines);

FIG. 2 shows a partial plan view of a footrest and support arm shown in FIG. 1;

FIG. 3 shows a partial side view of another embodiment of the invention comprising a suspension device attached to the support arm;

FIG. 4 shows a partial side view of another embodiment of the invention comprising a low set support arm extending from above the crankset, with a suspension device and seat post tube; and

FIG. 5 shows a side view of an embodiment of the invention comprising front and rear suspension devices, rear sprocket comprising a cluster of gears and seat.

### DETAILED DESCRIPTION OF THE INVENTION

In order that the invention may be readily understood and put into practical effect, particular preferred embodiments will now be described by way of the following non-limiting examples.

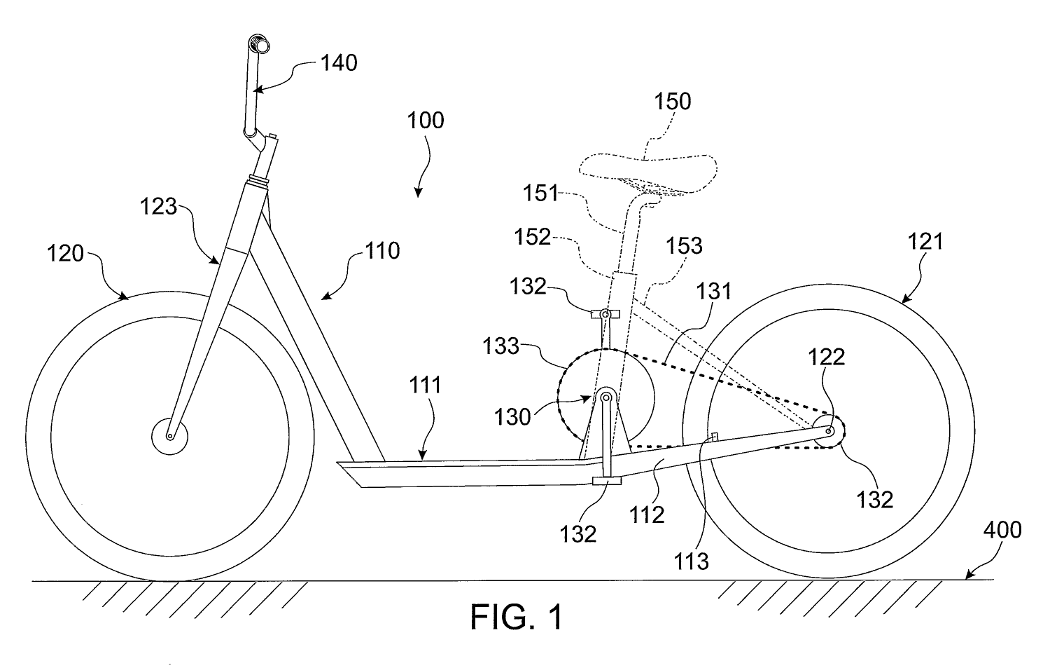

FIG. 1 shows a preferred embodiment of the invention shown as a scooter/bicycle vehicle 100. The scooter/bicycle 100 comprises a frame 110, a front wheel 120, a rear wheel 121, a crankset and bottom bracket 130 attached to a rear sprocket of gears 132 by a chain 131 and handle bar 140 as shown. The front wheel 120 and rear wheel 121 are shown as standard bicycle wheels. The front wheel 120 is attached to the frame 110 via forks 123. The wheels 120, 121 may for example comprise mountain bike, BMX bike, racing bike or hybrid bike type wheels as are known in the art. A pair of pedals 132 are attached to the crankset 130, such that when the crankset 130 and chain ring 133 are rotated, gear 132 and rear wheel 121 are also rotated in a similar manner as a typical bicycle.

A footrest 111 is located between the front wheel 120 and rear wheel 121. The footrest 111 is shown as a flat platform integrally formed with the frame 110. However, it is contemplated that other embodiments of the invention may comprise a footrest attachable to the frame 110 by way of a fastener, for example a clamp, bolt, weld, rivet or the like.

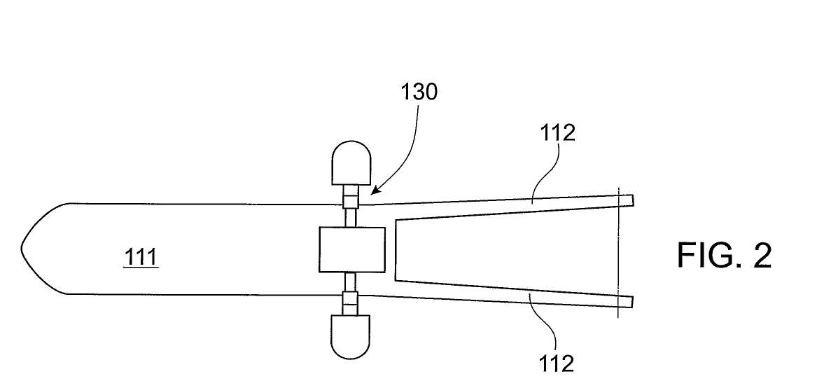

A pair of support arms 112 extend from the frame 110 and attach to either side of hub 122 of the rear wheel 121 as shown in FIGS. 1 and 2. The embodiment of the invention shown in FIG. 1 comprises a pair of support arms 112 located below the crankset 130, which provides a low set profile of a rear part of the frame 110 between the footrest 111 and rear wheel 121. The pair of support arms 112 is shown comprising a V-brake post 113 for mounting a typical V-brake as is common in the art. It will be appreciated, however, that other braking devices may be used, for example, coaster brakes or disk brakes.

It is preferred that the rear part of the scooter/bicycle 100 extending from the footrest 111 to the rear wheel 121 is low set such that a highest part of the rear part of the scooter/bicycle 100 is about equal to or lower than a top of the rear wheel 121 as shown in FIG. 1. For example, when the front wheel 120 and rear wheel 121 are both in contact with a planar surface 400 such as the ground, it is preferred that the frame 110 and pair of support arms 112 between the footrest 111 and rear wheel 121 are closer to the ground than a top part of the rear wheel 121. In a preferred embodiment of the invention shown in FIG. 1, this low set profile is achieved by locating the support arm 112 below the crankset 130. A typical bicycle has a rear support frame, commonly a triangular frame, which extends from a central part of the frame in line with the crankset to the rear wheel and a location of the frame above the crankset near the seat post. As such, a typical bicycle is characterised by a high rear profile, which is bulky and restricts movement over the rear part of the bicycle.

A person is able to ride the scooter/bicycle 100 in a manner similar to either a bicycle or a scooter. When riding the scooter/bicycle 100 as a bicycle, the person advances the scooter/bicycle 100 by rotating the pedals 132 about the crankset 130, which is connected to the rear wheel 121 via the chain 131 in a similar manner as a standard bicycle. When using the scooter/bicycle 100 as a scooter, a person places one foot on the footrest 111 and pushes off of the ground or other surface with the other foot.

The low set rear profile of the scooter/bicycle 100 allows a user to move freely about the scooter/bicycle 100, in particular about the rear part of the scooter/bicycle 100. For example, one or both legs of the user may be easily swung over a rear end of the frame 100 and rear wheel 121. This low set profile is preferable when performing tricks or stunts. Also, the scooter/bicycle 100 requires less material to construct when compared with a standard bicycle, which results in a less bulky profile and reduced manufacturing costs.

If preferred, the vehicle 100 may be provided with a bicycle-type seat 150, mounted on a seat post 151 telescopically required in a seat post tube 152 (connected to the rear of the arms 112 by a triangular strut 153).

FIG. 2 shows a plan view of part of the frame 110 comprising the footrest 111, part of the crankset 130 and a pair of support arms 112. The pair of support arms 112 is located around the rear wheel 121 when attached thereto.

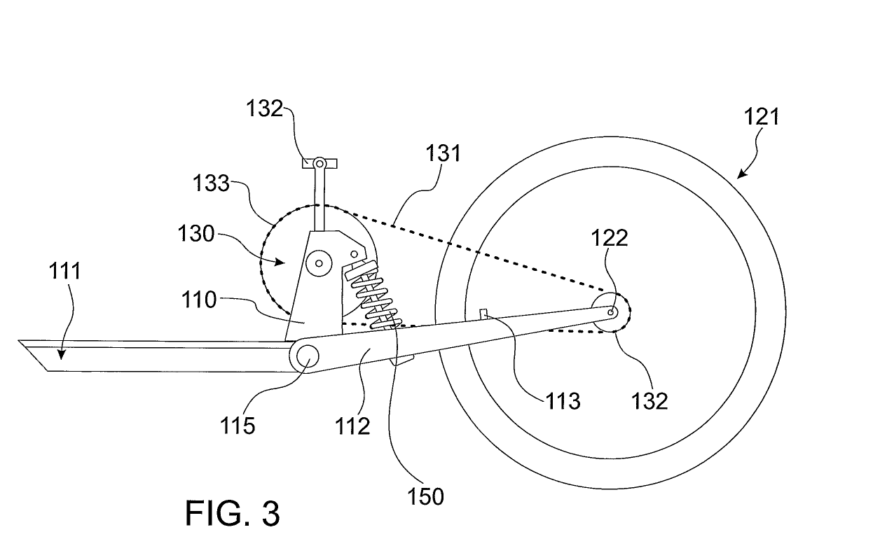

FIG. 3 shows a partial side view of another embodiment of the invention comprising a rear suspension device 150, shown as a coiled spring, attached to the frame 110 and support arm 112. The support arm 112 is pivotably attached to the frame 110 at location 115. The suspension device 150 is preferably attached to each arm of the pair of support arms 112 or attached to a cross member joining the pair of support arms 112.

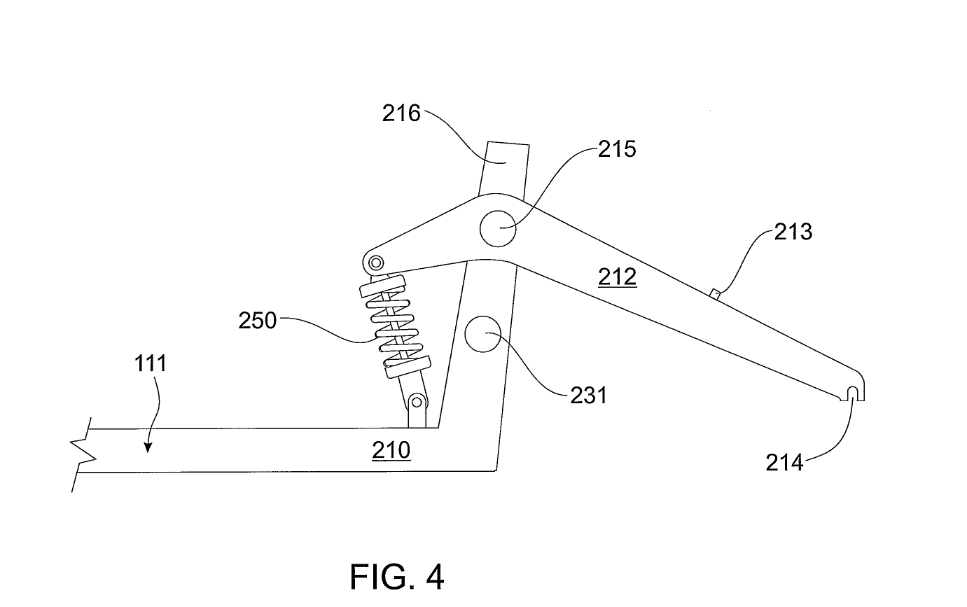

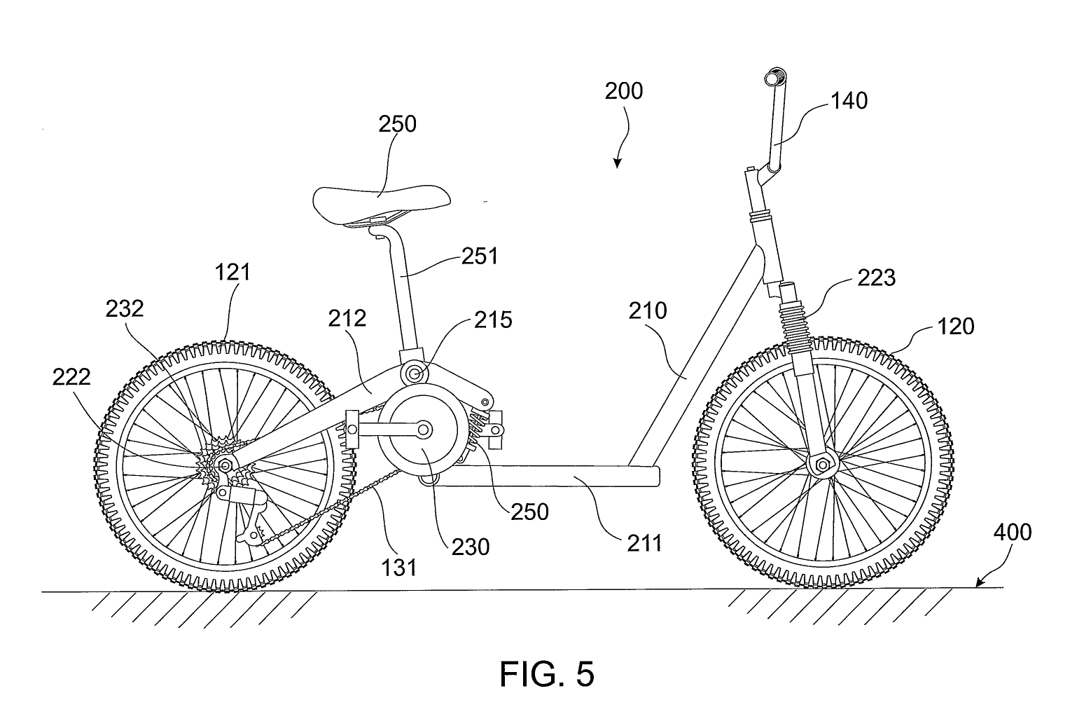

FIG. 4 shows another embodiment of the invention comprising a support arm 212 that is located above the crankset 230 (shown in FIG. 5), which is attachable to aperture 231. This embodiment comprises a suspension device 250, shown as a coiled spring, attached to the support arm 212 and frame 210. The suspension device 250 is preferably attached to each arm of the pair of support arms 212. The pair of support arms 212 is pivotably attached to the frame 210 at location 215. The pair of support arms 212 also comprises aV-brake post 213 for attaching a bake assembly and a notch 214 for attaching the rear wheel 121. Another embodiment of the invention may comprise a support arm 212 fixed to the frame 210, without suspension, in a similar manner as the embodiment shown in FIG. 1.

FIG. 5 shows another preferred embodiment of the invention 200 comprising frame 210, front wheel 120, rear wheel 121, crankset and bottom bracket 230 attached to a rear sprocket comprising a plurality of gears 232 by a chain 131 and handle bar 140. The frame 210 is shown comprising a footrest 211 and a rearwardly extending support arm 212 attached to the frame 210 and hub 222 of the rear wheel 121. A seat post tube 216 is located above the crankset 230 for attaching a seat 250 via seat post 251. The top of the seat post tube 216 is shown extending below a vertical height of the rear wheel 121 in FIG. 5. The scooter/bicycle 200 is shown comprising a front suspension device 223 and a rear suspension device 250, however, it will be appreciated that front and rear suspension devices 223, 250 are preferred options to provide a smoother ride over rough terrain. The rear suspension device 250 shown in FIG. 5 is the same shown in FIG. 4.

The seat 250 may provide a more comfortable ride when using the scooter/bicycle 200 in a manner similar to a bicycle. However, the seat 250 is optional and in use, a user may prefer that the seat 250 is removed to allow for the rear profile of the scooter/bicycle 200 to be low, e.g. about a height of the rear wheel 121 when both the front wheel 120 and the rear wheel 121 the scooter/bicycle 200 are in contact with a planar surface 400, such as the ground.

A vertical height of the frame 210 rearward of platform 211 is shown about equal to or less than a vertical height of the rear wheel 121. This low set rear profile allows a leg or other body part of a person to easily pass over the rearward part of the scooter/bicycle 200. This low rear profile is preferable when a person is pushing the scooter/bicycle 200 in a scooter-like manner with one foot located on the platform 211 and another foot is pushing off the ground to hereby advance the scooter/bicycle 200. Further, it is preferred that the scooter/bicycle 200 comprises a low rear profile to allow a person to perform tricks or stunts. Such tricks and stunts may be performed by a person as a form of entertainment and technical challenge. For example, a person may rotate the scooter/bicycle 200 about a central axis of the rear wheel 121 with the front wheel 120 suspended from the ground and a leg passing over the rearward part of the frame 210. A typical bicycle lacks a platform, has a top cross bar and has a high set rearward part of the frame, which is bulky and obstructs movement of a person's body over the rear part of the bicycle. The scooter/bicycle 100 of the present invention is less cumbersome than a bicycle, which allows a rider to manoeuvre the scooter/bicycle 100 easily, for example in when riding off-road or for tight radius turns.

It will be appreciated that the embodiment of the scooter/bicycle 100 shown in FIG. 1 may optionally comprise a seat, similar to that shown in FIG. 5. Also, the embodiment shown in FIG. 1 may comprise front and/or rear suspension and a plurality of rear gears and front chain rings as described herein.

It will be appreciated that other embodiments of the invention include forms of the scooter/bicycle 200 that comprise only a single rear gear instead of a cluster of gears 232, for example as shown for the embodiment in FIG. 1. The embodiment of the invention comprising a plurality of gears preferably comprises a rear derailleur. Also, the front crankset 130,230 may comprise one or more chain rings 133 for example, one, two, three, four or more chain rings 133. An embodiment of the invention comprising a plurality of chain rings 133 preferably also comprises a front derailleur. It will also be appreciated that although the chain 131 is a preferred linkage operatively connecting the crankset 130 to the rear gear 132 of the rear wheel 121, other linkages are contemplated, including a rotatable shaft, cable or other linkage.

It will be appreciated that the invention may comprise one or more suspension devices or may lack suspension. Suspension devices preferably include those known in the art, for example those shown in the figures as coiled springs and liquid filled cylinders, such as gas or oil filled shocks.

Embodiments of the invention may comprise a low set rear frame rather than a single arm or a pair of support arms 112, 212. For example, a low set rear frame may comprise a triangular frame or two pairs of support arms, preferably support arms 112 and support arms 212, either with or without suspension. An embodiment comprising a single arm rather than a pair of arms preferably attaches to one end of the hub of the rear wheel.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

1. A vehicle comprising:
a frame;
a footrest attached to or formed integrally with the frame;
a rear wheel attached to the arm(s);
a front wheel attached to a front part of the frame opposite the arm(s);
a crankset mounted to the frame between the front and rear wheels;
a drive mechanism operatively connecting the crankset to the rear wheel;
a pair of pedals attached to the crankset, the pedals adapted for rotating about the crankset; and
a handle bar attached to a front part of the frame;
wherein the footrest is located between the front and rear wheels and a height of the frame and arm(s) between the footrest and rear wheel is substantially equal to, or less than, a height of the rear wheel when measured from a planar surface on which both the front and rear wheels are located thereon.

2. The vehicle as claimed in claim 1, wherein the vehicle comprises a pair of the arms.

3. The vehicle comprising:
a frame;
a footrest attached to or formed integral with the frame;
a single pair of arms attached to and extending from the frame;
a rear wheel attached to the pair of arms;
a front wheel attached to a front pair of the frame opposite the arm;
a crankset mounted to the frame between the front and rear wheels;
a drive mechanism operatively connecting the crankset to the rear wheel;
a pair of pedals attached to the crankset, the pedals adapted for rotating about the crankset; and
a handle bar attached to a front part of the frame;
wherein the footrest is located between the front and rear wheels.

4. The vehicle as claimed in claim 1, wherein the footrest comprises a flat surface.

5. The vehicle as claimed in claim 2, wherein the pair of arms extends from the frame below the crankset; or the pair of arms extends from the footrest; or the pair of arms extend from the frame above the crankset.

6. The vehicle as claimed in claim 1, wherein the crankset comprises one or more chain rings; and the rear wheel comprises one or more gears.

7. The vehicle as claimed in claim 1, wherein the vehicle further comprises one or more braking devices.

8. The vehicle as claimed in claim 1, wherein the front wheel is attached to the frame via a set of forks.

9. The vehicle as claimed in claim 8, wherein the set of forks comprises a suspension device.

10. The vehicle as claimed in claim 1, wherein the arm, or pair of arms, comprises a suspension device.

11. The vehicle as claimed in claim 9, wherein each suspension device comprises a spring or liquid filled cylinder.

12. The vehicle as claimed in claim 11, wherein the liquid cylinder comprises a gas or oil filled cylinder.

13. vehicle as claimed in claim 1, wherein the drive mechanism connecting the crankset to the rear wheel comprises a chain.

14. The vehicle as claimed in claim 1, wherein the vehicle further comprises a seat attachable to the frame.

15. The vehicle as claimed in claim 2, wherein the footrest comprises a flat surface, wherein the pair of arms extends from the frame below the crankset, or the pair of arms extends from the footrest, or the pair of arms extend from the frame above the crankset, wherein the crankset comprises one or more chain rings and the rear wheel comprises one or more gears, wherein the vehicle further comprises one or more braking devices, wherein the front wheel is attached to the frame via a set of forks, and wherein the set of forks comprises a suspension device.

16. The vehicle as claimed in claim 3, wherein the footrest comprises a flat surface, wherein the pair of arms extends from the frame below the crankset, or the pair of arms extends from the footrest, or the pair of arms extend from the frame above the crankset, and wherein the crankset comprises one or more chain rings and the rear wheel comprises one or more gears.

17. The vehicle as claimed in claim 16, wherein the vehicle further comprises one or more braking devices, wherein the front wheel is attached to the frame via a set of forks, and wherein the set of forks comprises a suspension device.

18. The vehicle as claimed in claim 3, wherein the arm, or pair of arms, comprises a suspension device, and wherein each suspension device comprises a spring or liquid filled cylinder.

19. The vehicle as claimed in claim 18, wherein the liquid cylinder comprises a gas or oil filled cylinder.

20. The vehicle as claimed in claim 19, wherein the drive mechanism connecting the crankset to the rear wheel comprises a chain, and wherein the vehicle further comprises a seat attachable to the frame.
